(19) United States
(12) Patent Application Publication
(10) Pub. No.: US 2002/0088641 A1
(43) Pub. Date: Jul. 11, 2002

(54) Insulating structure for a coaxial cable and method for applying the same

(76) Inventors: Patricio G. Murga, Monterrey (MX); Sergio Montes, Monterrey (MX); Jose Ranc, San Pedro Garza Garcia (MX)

Correspondence Address: Abelman, Frayne & Schwab, 150 East 42nd Street, New York, NY, 10017-5612, US

(21) Appl. No.: 09/757,055

(22) Filed: Jan. 8, 2001

(51) Int. Cl. H01B 7/00

(52) U.S. Cl. 174/120 R

(57) ABSTRACT

An insulating structure for the central conductor of coaxial cables having an improved resistance to mechanical stress comprising an inner layer surrounding the central conductor having a bond strength to the central conductor of about 2 to about 20 lb.; an intermediate insulating layer surrounding the inner layer; and an outer insulating layer surrounding the intermediate insulating layer.

### BACKGROUND OF THE INVENTION

1. Field of the Invention

The present invention relates to coaxial cables, and more particularly to an insulating structure for the conductors of coaxial cables having improved resistance to mechanical stress and a method for its application.

2. Description of the Related Art

The dielectric and mechanical characteristics of the coaxial cables are of great importance in order to assure optimum data transmission and to avoid losses or distortion of data, mainly due to variations of the insulation dielectric characteristics.

A typical coaxial cable comprises a central copper conductor surrounded by an insulating foam layer; an aluminum layer surrounding the foam layer; a screen layer surrounding the aluminum layer, and an external plastic layer surrounding the screen layer. Other typical coaxial cable designs include an additional layer of a solid material surrounding the central conductor, this layer being enclosed and surrounded by the insulating foam layer previously described.

The insulating structure which surrounds the central conductor has several functions, such as separation of the central conductor from the outer conductor, and to assure the electrical properties of the cable.

The first inner layer serves the purpose of assuring an adequate level of adhesion between the central conductor and the foam insulating layer, whereas the foam layer separates the inner and outer conductors while keeping the dielectric losses to a minimum.

Air is known as one of the best available insulators and the foam is typically made from a foamed compound having a high content of air bubbles which serve as an excellent insulator. Therefore, the more air bubbles the foam layer has, the better will be the insulating properties.

It has been observed that when the coaxial cable is severely manipulated, the material of the foam layer tends to be extremely compressed or to bent due to mechanical stresses, which deform the air bubbles contained in the foam layer, thus affecting its insulation properties.

In a typical coaxial cable the mechanical stress which occurs during a severe manipulation, causes variations of the insulating foam thickness which affects the roundness of the insulation structure, and consequently causing variations in its dielectric properties, leading to distortion of data, data losses, etc. In addition, moisture can penetrate into the foamed insulating layer causing deterioration in its dielectric properties.

Therefore, it would be highly desirable to have an insulating structure having additional protection for the insulating foam layer against external agents, such as mechanical stress and moisture, in order to preserve its dielectric properties and thus the properties of the coaxial cable.

In view of the above-referenced problems, an insulating structure has been developed which adequately protects the foam against mechanical stress and moisture.

The insulating structure comprises an inner layer surrounding a conductor core having a bond strength to the conductor core of about 2 to about 20 lb; an insulating layer surrounding the inner layer; and a solid outer insulating layer surrounding the insulating layer.

There is also provided a method for applying the insulating structure over a conductor core which comprises the steps of: applying an inner layer over a conductor core; applying an insulating layer over the inner layer simultaneously with the application of the inner layer; and applying a solid outer layer over the insulating layer simultaneously with the application of the inner layer and with the application of the insulating layer.

By virtue of the insulating structure of the present invention, there is achieved a longer useful life for the entire coaxial cable, clearer transmissions due to its double layer insulating protection and improved tolerance of the coaxial cable to severe conditions of use without the risk of damaging the foam layer.

### SUMMARY OF THE INVENTION

It is therefore an object of the present invention, to provide an insulating structure for the central conductor of coaxial cables having an improved resistance to mechanical stress.

It is also an object of the present invention to provide an insulating structure of the above-disclosed nature, which adequately protects the insulating layer.

It is another object of the present invention to provide an insulating structure of the above-disclosed nature which maintains its dielectric properties during severe manipulation.

It is a further object of the present invention to provide an insulating structure of the above-disclosed nature by which there is achieved a longer life for the entire coaxial cable.

It is yet a further object of the present invention to provide an insulating structure of the above-disclosed nature by which a better tolerance of the coaxial cable to severe conditions of use is achieved without the risk of damaging the insulating layer and, thus, reliability of transmission.

It is still a further object of the present invention to provide a method for applying an insulating structure over a conductor core.

These and other objects and advantages of the insulating structure and method for its application in accordance with the present invention will become apparent to those persons having ordinary skill in the art, from the following detailed description of the embodiments of the invention which will be made with reference to the accompanying drawing.

### BRIEF DESCRIPTION OF THE DRAWINGS

FIG. 1 is a view of the cross section of a cable having the insulating structure of the present invention.

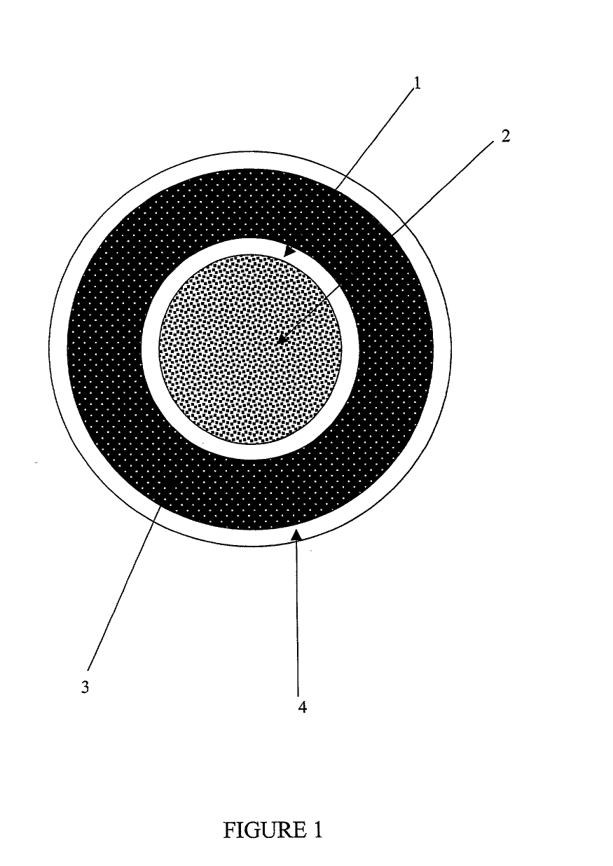

### DETAILED DESCRIPTION OF THE INVENTION

The insulating structure of the present invention will be described in accordance with a preferred embodiment thereof as illustrated in the accompanying drawing wherein the same numbers refer to the same parts of the figure.

The insulating structure comprises an inner layer 1, which surrounds a conductor core 2, which comprises a layer made from a solid dielectric material, generally a polyolefin selected from the group consisting of low density polyethylene, linear low density polyethylene, medium density polyethylene, high density polyethylene, ionically cross-linked thermoplastic polymer, i.e. ionomer, ethylene vinyl acetate copolymer, ethylene-alpha-olefin copolymer, and blends or mixtures thereof. Preferably a linear low density polyethylene is employed, the inner layer having a bond strength to the conductor core of about 2 to about 20 lb, most preferably about 5 to about 15 lb, for assuring a satisfactory bond between the central conductor and subsequent insulating layer.

An insulating layer 3, which surrounds the inner layer 1, comprises a layer of a foamed compound made by any known means or processes. The foamed compound is preferably made by injecting nitrogen gas to an expansion degree of about 10 to about 80%, the foam generally comprising a foamed polyolefin wherein the polyolefin is selected from low density polyethylene, medium density polyethylene, high density polyethylene, ethylene-alpha-olefin copolymers, and blends or mixtures thereof. The foamed compound is blended with an effective amount of a nucleating agent, and has a low dielectric constant value of about 1.2 to about 2.1, preferably from about 1.3 to about 1.5, due to a high content of air in the form of air bubbles, as a result of which the overall dielectric constant of the multi-layer cable is optimized without increasing its thickness and by means of which variations in the dielectric constant are minimized which allows minimal variations in the cable transmission characteristics.

An outer insulating layer 4, which surrounds the insulating layer 3, comprises a layer of a solid insulating compound having a dielectric constant of about 2 to about 4. Generally a polyolefin selected from the group consisting of low density polyethylene, medium density polyethylene, high density polyethylene, polypropylene, ethylene-alpha-olefin copolymer and blends or mixtures is employed as the outer insulating layer 4 thereof. Preferably, a medium density polyethylene is employed which protects the insulating layer 3 from mechanical damage thus avoiding the destruction of the foam air bubbles. Furthermore, it provides an additional insulating layer which improves the dielectric properties of the entire coaxial cable.

Although the insulating layer 3 has been described as being comprised of a foamed compound, it may be comprised of any type of material, even a solid material, provided it has a low dielectric constant, such as from about 2 to about 3.

The method for applying the insulating structure to a conductor core comprises the steps of:

applying an inner layer over the conductor core, the inner layer being made from a solid dielectric material;

applying an insulating layer over the inner layer simultaneously with the application of the inner layer, the insulating layer comprising a layer of a foamed compound; and

applying an outer solid insulating layer over the insulating layer simultaneously with the application of the inner layer and with the application of the outer insulating layer, the outer insulating layer comprising a solid but flexible layer of an insulating compound.

Finally it should be understood that the insulating structure and the method for its application in accordance with the present invention, is not limited exclusively to the above described and illustrated embodiments and that persons having ordinary skill in the art can, with the teaching provided by this invention, make modifications to the design, component distribution or steps of the insulating structure and method for applying thereof of the present invention, which will clearly be within the true inventive concept and scope of the invention which is set forth in the following claims.

What is claimed is:

1. An insulating structure for a coaxial cable comprising:
a) an inner layer surrounding a central conductor having a bond strength to the central conductor of about 2 to about 20 lbs.;
b) an intermediate insulating layer surrounding the inner layer; and
c) an outer insulating layer surrounding the intermediate insulating layer.

2. An insulating structure according to claim 1, wherein the inner layer is made from a solid dielectric material comprising a polyolefin selected from the group consisting of a low density polyethylene, linear low density polyethylene, medium density polyethylene, high density polyethylene, ionically cross-linked thermoplastic polymer i.e. ionomer, ethylene vinyl acetate copolymer, ethylene-alpha-olefin copolymer and blends or mixtures thereof.

3. An insulating structure according to claim 1, wherein the inner layer has a bonding strength to the central conductor of about 5 to about 15 lb.

4. An insulating structure according to claim 1, wherein the intermediate insulating layer is made of a foamed compound comprising a foamed polyolefin selected from the group consisting of low density polyethylene, medium density polyethylene, high density polyethylene, ethylene-alpha-olefin copolymers and blends or mixtures thereof blended with an effective amount of a nucleating agent.

5. An insulating structure according to claim 1, wherein the intermediate insulating layer is made of a foamed compound formed by injecting nitrogen as a blowing agent.

6. An insulating structure according to claim 1, wherein the intermediate insulating layer is made of a foamed compound having a degree of expansion of about 10% to 80%.

7. An insulating structure according to claim 1, wherein the intermediate insulating layer has a dielectric constant of about 1.2 to about 2.1.

8. An insulating structure according to claim 1, wherein the intermediate insulating layer is made of a solid insulating material.

9. An insulating structure according to claim 1, wherein the outer insulating layer is made of a polymer selected from the group consisting of low density polyethylene, medium density polyethylene, high density polyethylene, polypropylene, ethylene-alpha-olefin copolymer, and blends or mixtures thereof.

10. An insulating structure according to claim 1, wherein the outer insulating layer has a dielectric constant of about 2 to about 4.

11. A method for applying an insulating structure to a conductor core comprising the steps of:
applying an inner layer over a conductor core;
applying an insulating layer over the inner layer simultaneously with the application of the inner layer; and
applying an outer insulating layer over the insulating layer simultaneously with the application of the inner layer and with the application of the insulating layer.
